(19) United States
(12) Patent Application Publication
(10) Pub. No.: US 2015/0315970 A1
(43) Pub. Date: Nov. 5, 2015

(54) BASELOAD EFFICIENCY IMPROVEMENT BY USING CHILLED WATER IN EVAPORATIVE COOLER IN LNG APPLICATION

(71) Applicant: General Electric Company, Schenectady, NY (US)

(72) Inventors: Joseph John, Bangalore (IN); Bhaskar Pemmi, Bangalore (IN); Veerappan Muthaiah, Bangalore (IN)

(73) Assignee: General Electric Company, Schenectady, NY (US)

(21) Appl. No.: 14/265,438

(22) Filed: Apr. 30, 2014

(51) Int. Cl. F02C 7/224; F02C 3/24

(52) U.S. Cl. CPC F02C 7/224; F02C 3/24

(57) ABSTRACT

A heat exchange circuit in a gas turbine includes an evaporative cooling medium circuit circulating an exchange medium, and a cooling source containing fuel. The cooling source is coupled with a supply line in a heat exchange relationship with the evaporative cooling medium circuit. The exchange medium is cooled by the fuel in the supply line, and the evaporative cooling medium circuit directs the cooled exchange medium through the evaporative cooler. The fuel is heated by the evaporative cooling medium circuit, and the supply line directs the heated fuel to the one or more combustors of the gas turbine. The cooler turbine inlet air results in increased baseload output.

### BACKGROUND OF THE INVENTION

The invention relates to gas turbines and, more particularly, to gas turbines including a heat exchange circuit that integrates cold energy available from a fuel source with an evaporative cooler.

Gas turbines are widely used in commercial operations for power generation. FIG. 1 illustrates a typical gas turbine 10 known in the art. As shown in FIG. 1, the gas turbine 10 generally includes a compressor 12 at the front, one or more combustors 14 around the middle, and a turbine 16 at the rear. The compressor 12 and the turbine 16 typically share a common rotor. The compressor 12 progressively compresses a working fluid and discharges the compressed working fluid to the combustors 14. The combustors 14 inject fuel into the flow of compressed working fluid and ignite the mixture to produce combustion gases having a high temperature, pressure, and velocity. The combustion gases exit the combustors 14 and flow to the turbine 16 where they expand to produce work.

In recent years, natural gas fuel prices have continued to increase dramatically, forcing combustion turbine power plants to explore alternatives to natural gas fuels. Many power plants are evaluating use of alternate fuels such as liquefied natural gas (LNG). The LNG is typically stored in a cylinder in liquid form at a temperature of (−260° F. to −160° F.) under pressure (about 400 psia). Gas turbine efficiency can be improved by employing an available source of heat such as low energy steam or water to preheat the fuel entering the gas turbine combustor. The LNG needs to be heated to a prerequisite degree (usually to 80-120° F.) before being fed to the gas turbine combustor. Currently, electric heaters are used to heat the LNG.

Evaporative coolers are used to cool the compressor inlet to maximize base load output. The evaporative cooler is particularly useful in hot ambient areas and helps in reducing the compressor inlet temperature by heat and mass transfer. The capability of the evaporative cooler can be increased by reducing the temperature of the water going into the evaporative media.

### BRIEF DESCRIPTION OF THE INVENTION

In an exemplary embodiment, a heat exchange circuit in a gas turbine includes an evaporative cooling medium circuit circulating an exchange medium, and a cooling source containing fuel. The cooling source is coupled with a supply line in a heat exchange relationship with the evaporative cooling medium circuit. The exchange medium is cooled by the fuel in the supply line, and the evaporative cooling medium circuit directs the cooled exchange medium through the evaporative cooler. The fuel is heated by the evaporative cooling medium circuit, and the supply line directs the heated fuel to the one or more combustors of the gas turbine.

In another exemplary embodiment, a gas turbine includes a compressor, a combustor receiving compressed air from the compressor, a turbine receiving combustion gases from the combustor, and an evaporative cooler disposed upstream of the combustor. The evaporative cooler cools the compressed air input to the combustor. A fuel source is in fluid communication with the combustor by a fuel supply line, and the combustor injects fuel from the fuel source into the compressed air from the compressor and ignites the mixture to produce the combustion gases. The gas turbine also includes a heat exchange circuit with an evaporative cooling medium circuit circulating an exchange medium, and a heat exchange portion of the fuel supply line in a heat exchange relationship with the evaporative cooling medium circuit. The exchange medium is cooled by the fuel in the supply line, and the evaporative cooling medium circuit directs the cooled exchange medium through the evaporative cooler. The fuel is heated by the evaporative cooling medium circuit, and the supply line directs the heated fuel to the combustor.

In yet another exemplary embodiment, a method of operating a gas turbine includes the steps of (a) circulating an exchange medium through a heat exchanger upstream of the evaporative cooler; (b) directing fuel through the heat exchanger with a fuel supply line upstream of the one or more combustors; (c) cooling the exchange medium in the heat exchanger by the fuel in the supply line; (d) directing the cooled exchange medium through the evaporative cooler; (e) heating the fuel in the heat exchanger with the exchange medium; and (f) directing the heated fuel to the one or more combustors of the gas turbine.

### BRIEF DESCRIPTION OF THE DRAWINGS

FIG. 1 is a schematic drawing of a typical gas turbine; and

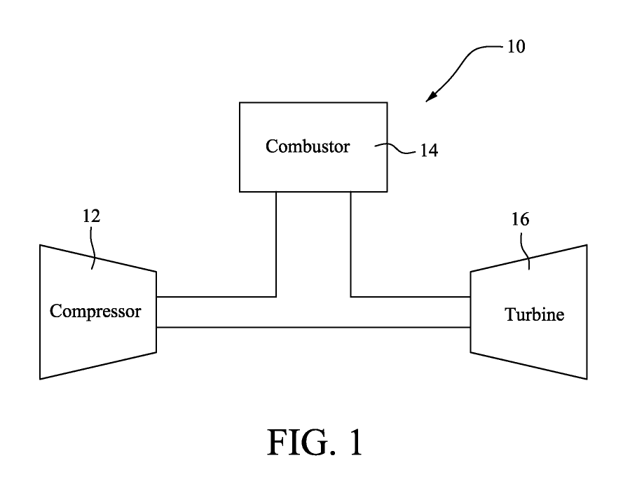

FIG. 2 shows a gas turbine including a heat exchanger and an evaporative cooler according to preferred embodiments.

### DETAILED DESCRIPTION OF THE INVENTION

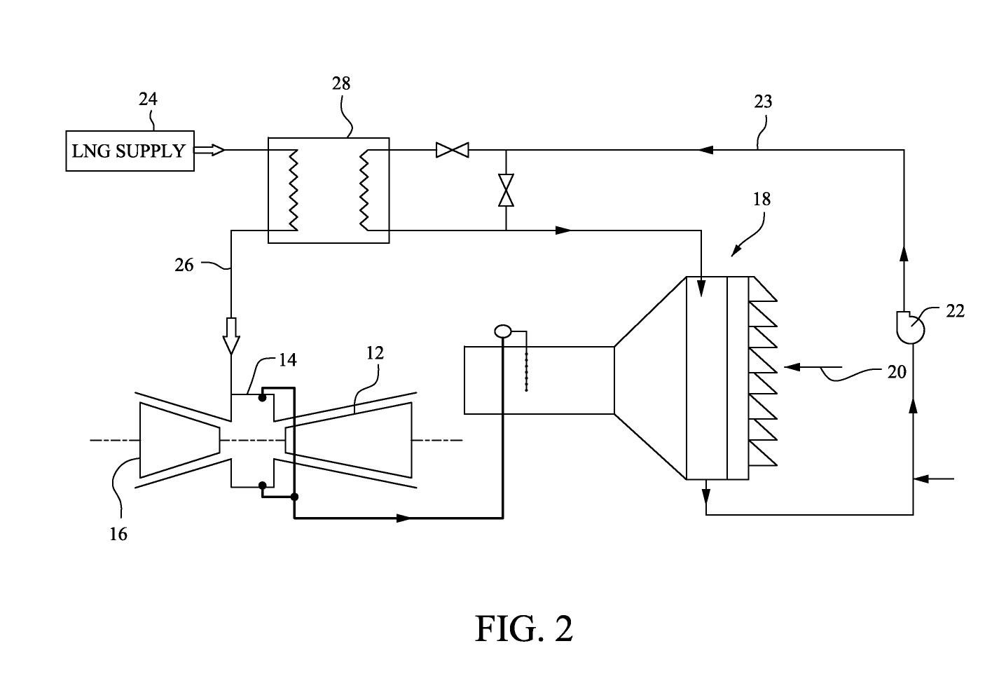

With reference to FIG. 2, an evaporative cooler is positioned upstream of the turbine. The evaporative cooler 18 draws ambient air flow 20 to be mixed with fuel in the combustor 14. The cooler 18 incorporates a heat exchange relationship with the ambient air flow 20 to cool the air below ambient temperature. A pump 22 or the like circulates an exchange medium via an evaporative cooling medium circuit 23 through the evaporative cooler 18 that is used to cool the ambient air flow 20 in a heat exchange relationship. Preferably, the exchange medium is water at ambient temperature.

A fuel source 24 delivers fuel, preferably liquefied natural gas (LNG), to the combustor 14 by a fuel supply line 26. Downstream of the fuel source 24 and upstream of the combustor 14 is a heat exchanger 28 through which the fuel supply via a heat exchange portion of the fuel supply line 26 and the evaporative cooling medium circuit 23 are in a heat exchange relationship.

The fuel thus serves as a cooling source to cool the exchange medium in the evaporative cooling medium circuit 23, and the exchange medium serves as a heating source to heat the fuel prior to injection into a combustor 14. Downstream of the heat exchanger 28, the exchange medium is cooled below ambient air temperature, and the cooler exchange medium reduces a temperature of the ambient air drawn in through the evaporative cooler 18. The exchange medium downstream of the evaporative cooler 18 has been heated by the ambient air flow 20 and is recirculated by the pump 22 through the heat exchanger 28.

The LNG is at a very low temperature (about −260° F. to −160° F.) depending on the pressure of the storage container to keep it in a liquefied state. For power generation, the LNG is gasified by releasing the pressure, and the LNG is heated to a desirable temperature for combustion in the turbine combustor. The heat exchanger circuit makes use of a chilling effect of the fuel (before being heated) to reduce the temperature of the exchange medium going into the evaporative cooler, thereby reducing the temperature of the compressor inlet air, while also heating the fuel to a prerequisite temperature (e.g., 80° F.). The increased effectiveness of gas turbine inlet air cooling helps to increase the base load output.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A heat exchange circuit in a gas turbine, the gas turbine including a compressor, one or more combustors, a turbine, and an evaporative cooler that conditions air input to the one or more combustors, the heat exchange circuit comprising:
an evaporative cooling medium circuit circulating an exchange medium; and
a cooling source containing fuel, the cooling source being coupled with a supply line in a heat exchange relationship with the evaporative cooling medium circuit,
wherein the exchange medium is cooled by the fuel in the supply line, the evaporative cooling medium circuit directing the cooled exchange medium through the evaporative cooler, and wherein the fuel is heated by the evaporative cooling medium circuit, the supply line directing the heated fuel to the one or more combustors of the gas turbine.

2. A heat exchange circuit according to claim 1, wherein the exchange medium is water at ambient temperature.

3. A heat exchange circuit according to claim 2, wherein the evaporative cooling medium circuit comprises a pump to circulate the water.

4. A heat exchange circuit according to claim 1, wherein the fuel comprises liquefied natural gas.

5. A heat exchange circuit according to claim 4, wherein the cooling source comprises a supply of liquefied natural gas stored under pressure in a cylinder.

6. A gas turbine comprising:
a compressor;
a combustor receiving compressed air from the compressor;
a turbine receiving combustion gases from the combustor;
an evaporative cooler disposed upstream of the combustor, the evaporative cooler cooling the compressed air input to the combustor;
a fuel source in fluid communication with the combustor by a fuel supply line, wherein the combustor injects fuel from the fuel source into the compressed air from the compressor and ignites the mixture to produce the combustion gases; and
a heat exchange circuit, including:
an evaporative cooling medium circuit circulating an exchange medium, and
a heat exchange portion of the fuel supply line in a heat exchange relationship with the evaporative cooling medium circuit,
wherein the exchange medium is cooled by the fuel in the supply line, the evaporative cooling medium circuit directing the cooled exchange medium through the evaporative cooler, and wherein the fuel is heated by the evaporative cooling medium circuit, the supply line directing the heated fuel to the combustor.

7. A gas turbine according to claim 6, wherein the exchange medium is water at ambient temperature.

8. A gas turbine according to claim 7, wherein the evaporative cooling medium circuit comprises a pump to circulate the water.

9. A gas turbine according to claim 6, wherein the fuel comprises liquefied natural gas.

10. A gas turbine according to claim 9, wherein the cooling source comprises a supply of liquefied natural gas stored under pressure in a cylinder.

11. A method of operating a gas turbine including a compressor, one or more combustors, a turbine, and an evaporative cooler, the method comprising:
(a) circulating an exchange medium through a heat exchanger upstream of the evaporative cooler;
(b) directing fuel through the heat exchanger with a fuel supply line upstream of the one or more combustors;
(c) cooling the exchange medium in the heat exchanger by the fuel in the supply line;
(d) directing the cooled exchange medium through the evaporative cooler;
(e) heating the fuel in the heat exchanger with the exchange medium; and
(f) directing the heated fuel to the one or more combustors of the gas turbine.

12. A method according to claim 11, wherein step (a) is practiced with a pump.

13. A method according to claim 11, wherein step (c) is practiced to reduce a temperature of the exchange medium to below an ambient temperature.

14. A method according to claim 11, wherein step (e) is practiced to increase a temperature of the fuel to at least 80° F.

15. A method according to claim 11, wherein after step (d), the exchange medium is re-circulated through the heat exchanger.
